(19) United States
(12) Patent Application Publication
(10) Pub. No.: US 2012/0075195 A1
(43) Pub. Date: Mar. 29, 2012

(54) Digital text-based communication and recording device for divers

(76) Inventor: James H. Broder, Vienna, VA (US)

(21) Appl. No.: 12/924,497

(22) Filed: Sep. 29, 2010

(51) Int. Cl. G06F 3/02

(52) U.S. Cl. 345/169

(57) ABSTRACT

The invention described herein is a submersible digital slate for divers that incorporates a power supply, a keyboard or keypad for text entry and a display screen for displaying text that can be attached and detached from a body-mountable retaining band or strap.

i) Text can be entered more quickly by keypad than by writing by hand;

ii) Text is clearly visible even under poor lighting conditions (as a result of an integrated display backlight) since digital text does not depend on the quality of the penmanship of the slate operator;

iii) Even small manual slates are generally too bulky to be easily mounted for carriage when not in use, yet readily accessible when needed; and

iv) Text can be erased or scrolled through in real time during a dive, and the storage capacity of a digital dive slate far surpasses that of a manual slate for writing by hand.

### DETAILED DESCRIPTION OF THE INVENTION

The invention described herein is a removable and body-mountable digital slate for divers that can be removed from a strap containing a base with a retaining clip. Preferable mounting locations are the wrist, forearm, upper arm or leg. The invention incorporates a power supply, a keyboard or keypad for text entry and a display screen. The invention is housed in a case that is water and pressure resistant to diving depths. The invention is used for underwater message creation and viewing and data recording. The full functionality of the device could also be integrated into current or future implementations of dive computer, which are produced by a variety of manufacturers.

The invention can also optionally contain such features and functionality as:

i) Backlighting for the display and backlighting or a glow-in-the-dark keyboard for use during night dives or dives with poor lighting conditions and visibility;

ii) A resealable battery compartment that may use a flexible O-ring seal, including, among others, standard scuba tank valve O-rings;

iii) Neutral, positive or negative buoyancy characteristics controlled by modifying the device design to allow for a larger or smaller air cavity within the housing or case;

iv) A keyboard with liquid-filled keys and/or keypad compartment to resist pressure;

v) Wrist- and/or body-mounting characteristics such as a watch-type or elastic band; and

vi) Integration of other features such as a clock and dive timer.

I claim:

1. A device with a power source, display and text entry keyboard or keypad integrated into a housing or case that is water and pressure resistant to recreational diving depths, and which is used for underwater message creation and viewing and data recording.

2. The device can be a stand-alone unit or have its functionality integrated into a dive computer.

3. The device further is body-mountable with an easily removable band or strap containing a retaining clip, and the keyboard may have liquid filled keys to resist water pressure at diving depths.
